(19) United States
(12) Patent Application Publication
(10) Pub. No.: US 2004/0160460 A1
(43) Pub. Date: Aug. 19, 2004

(54) Systems and methods for delivering a data stream to a video appliance

(75) Inventors: Steven M. Casey, Littleton, CO (US); Bruce A. Phillips, Erie, CO (US); Donald Brodigan, Broomfield, CO (US); Kurt A. Campbell, Lafayette, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO

(21) Appl. No.: 10/367,596

(22) Filed: Feb. 14, 2003

(51) Int. Cl. H04N 11/00; G09G 5/02

(52) U.S. Cl. 345/718; 348/446; 348/552; 345/603

(57) ABSTRACT

Systems and methods are described for delivering a data stream to a video appliance. The data stream may have a computer video signal, such as provided by the output of a computational device. The data stream is received from the computational device. The computer video signal is converted to a converted television video signal, which is combined with television video signals received from an external source. The combined television video signals are transmitted to the video appliance.

### BACKGROUND OF THE INVENTION

This application is related to generally to systems and methods for delivering a data stream to a video appliance. More specifically, this application is related to delivering a data stream from a computational device to a video appliance.

In recent years, as recreational use of the Internet has steadily increased, there has been a generally corresponding decrease in the average number of hours spent watching television. These concomitant trends are widely believed to be related, and to reflect the fact that the availability of the Internet has caused a shift in the use of leisure time by individuals away from watching television and towards using the Internet. Accordingly, a number of attempts have been made to integrate television watching with Internet usage, but these suffer from a number of deficiencies.

For example, one attempt that has been made is in the form of variety of commercially available products called “WebTV Internet Terminals,” available from such manufacturers as Sony, Thomson Consumer Electronics, and Philips. Such products are designed to interface directly with a consumer's home television and thereby provide access to the Internet through the television. A wireless keyboard may be provided to act as an input device to the terminal. In some instances, the picture-in-picture (“PIP”) feature of the consumer's television may be used to provide a small PIP screen that shows a television broadcast signal while the user is using the main screen for Internet access. While this arrangement may be suitable for some applications, it is sharply limited in utility by the fact that, in effect, it is merely turning an existing television set into a monitor for an Internet-access device. In particular, such systems effectively remove the versatility afforded by separate Internet-access and broadcast-television-access devices in an effort to integrate those activities. For example, if there are two individuals within a household, one of which wants only to watch television and one of which only wishes to access the Internet, such systems are unable to accommodate that behavior.

Such a deficiency exists in other proposals as well. For example, some manufacturers have marketed modified television sets that have built-in Internet-access capability or have marketed computers that include television viewing capability. There is accordingly a persistent need in the art for methods and systems that retain the flexibility of separate Internet-access and television devices while still providing the capability of an integration of that access.

### BRIEF SUMMARY OF THE INVENTION

Embodiments of the invention thus provide methods and systems for delivering a data stream to a video appliance that permit the desired flexibility. The data stream may have a computer video signal, such as provided by the output of a computational device. In one set of embodiments, the data stream is received from the computational device. The computer video signal is converted to a converted television video signal, which is combined with a plurality of television video signals received from an external source. The combined television video signals are transmitted to the video appliance.

The converted television video signal may also be rf modulated, thereby permitting the converted television video signal to be selected for display on the video appliance by tuning the video appliance. Converting the computer video signal may comprise changing a refresh rate of the computer video signal to accommodate a desired refresh rate in the television video signal, such as when a conversion is made from a VGA signal to an NTSC, PAL, or SECAM signal. In one embodiment, one of the plurality of television video signals received from the external source may be displayed on the video appliance simultaneously with the converted television video signal, such as may be accomplished using a picture-in-picture capability of the video appliance. The data stream may encompass a variety of different types of information and, in one embodiment, is extracted from an Internet site. In some embodiments, the converted television video signal may be stored, permitting it to be retrieved prior to combining it with the plurality of television video signals.

In some embodiments, a plurality of data streams may be accommodated. For example, in one embodiment the data stream is one of a plurality of data streams provided by a plurality of computational devices, and the method further comprises selecting the data stream from the plurality of data streams. In another embodiment, a second data stream having a second computer video signal is received from a second computational device. The second computer video signal is converted to a second converted television video signal, which is combined with the converted television video signal and the plurality of television video signals received from the external source. The converted television video signal may be rf modulated with a first modulation, and the second converted television video signal may be rf modulated with a second modulation; this thereby permits either of the converted television video signals to be selected for display on the video appliance by tuning the video appliance. In some instances, both the converted television video signal and the second converted television video signal are displayed simultaneously on the video appliance.

In another set of embodiments, a data appliance is provided. The data appliance comprises a conversion element adapted to convert a received computer video signal to a converted television video signal. It also comprises a combiner adapted to combine the converted television video signal with a plurality of television video signals received from an external source. A processor is communication with the conversion element and with the combiner is adapted to coordinate operation of the conversion element and the combiner. In a specific embodiment, the processor includes an interface for accepting programming information.

In some such embodiments, the data appliance may further comprise an rf modulator adapted to modulate the converted television video signal. The processor is further in communication with and adapted to coordinate operation of the rf modulator. In other embodiments, the data appliance may further comprise a storage device adapted to store the converted television video signal. In one embodiment, the conversion element may be further adapted to convert a second received computer video signal to a second converted television signal, with the combiner further adapted to combine the second converted television signal with the converted television video signal and the plurality of television video signals received from the external source. In such an embodiment, the data appliance may additionally comprise first and second rf modulators respectively adapted to modulate the converted television video signal and the second converted television video signal with different modulations.

In a further set of embodiments, a system is provided. The system comprises a video appliance, a computational device, and a data appliance. The data appliance is adapted to receive a data stream having a computer video signal from the computational device and to transmit a conversion of the computer video signal to a converted television video signal to the video appliance as part of a plurality of television video signals. In one embodiment, the data appliance may be further adapted to combine the converted television video signal with a plurality of television video signals received from an external source. In another embodiment, the data appliance may be further adapted to rf modulate the converted television video signal. The video appliance may be adapted to accept tuning information to select the converted television video signal from the plurality of television video signals according to a modulation provided by the data appliance. In one instance, the video appliance is adapted to display multiple of the plurality of television video signals simultaneously. The computational device may include a connection to an Internet site, with the data stream being extracted from the Internet site.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a schematic diagram providing an overview of embodiments of the invention;

FIG. 2 is a schematic diagram illustrating a structure of a data appliance used in embodiments of the invention;

FIGS. 3A and 3B are schematic diagrams of structures of computer-video-TV-video converters used in embodiments of the invention; and

FIG. 4 is a flow diagram illustrating aspects of methods used in embodiments of the invention.

### DETAILED DESCRIPTION OF THE INVENTION

Embodiments of the invention provide methods and systems for delivering a data stream to a video appliance. In particular, specific configurations permit a video appliance to be used simultaneously to view television video signals and to view computer video signals originating from a computational device. As used herein, the term “television video signals” refers to electronic signals provided according to a protocol that permits their representation in the form of visual images on a television. Examples of television video signals thus includes signals provided in accordance with protocols established by the National Television System Committee (“NTSC”) in North America, signals provided in the Phase Alternation Line (“PAL”) format common for western European and Australian television, signals provided in the PAL-M format common for much of Brazilian television, signals provided in the PAL-N format common for Argentinean television, signals provided in the Sequentiel Couleur Avec Memoire (“SECAM”) format used for French color television and in parts of the Middle East, and the like. As used herein, the term “computer video signals” refers to electronic signals provided according to a protocol for presentation in the form of visual images by a computer. Examples of computer video signals thus includes signals provided in accordance with the Video Graphics Array (“VGA”) protocols (640×480 pixels), the SuperVGA (“SVGA”) protocols (800×600 pixels), the eXtended Graphics Array (“XGA”) protocols (1024×768 pixels), the XGA-2 protocols (1152×864 pixels), the SuperXGA (“SXGA”) protocols (1280×1024 pixels), and the like.

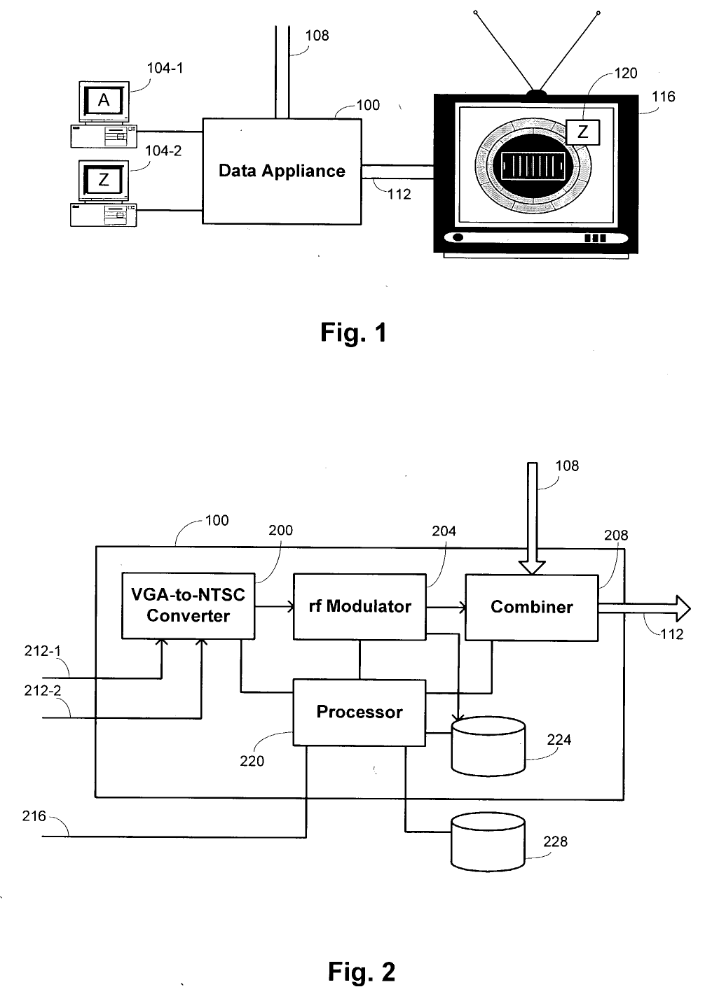

An overview of one structure that may be used to provide such functionality is shown in FIG. 1. In this figure, the video appliance is shown as a television set 116 having PIP capability, although such capability is not required in all embodiments. In alternative embodiments, different video appliances may alternatively be used, including, for example, video appliances having split-screen capability. A data appliance 100 is configured to accept computer video signals from one or more computational devices 104, which may include, for example personal computers, laptops, personal digital assistants (“PDAs”), and the like. In addition, the data appliance 100 is configured to accept television video signals 108 from an external source, such as may be provided by a cable-television or satellite-television provider. The data appliance 100 selects one of the computer video signals in accordance with a state of the data appliance 100 and converts the selected signal to a television video signal, which is combined with the external television video signals 108. In performing the combining, the converted video signal may be provided on a channel unused by the external source or may substitute for a specified channel. For example, where a user never watches a particular channel because its content is provided in a foreign language or is not of any interest to the user, that channel may be substituted by the data appliance 100 with the converted channel from one of the computational devices 104.

The combined signal 112 is provided to the video appliance 116, such as over internal coaxial cable lines within the premises of a customer. The converted computer video signal comprised by the combined signal 112 is assigned by the data appliance 100 to a particular channel, enabling the video appliance 116 to tune to the converted signal as desired. In some embodiments, the data appliance 100 may be configured to provide a plurality of converted computer video signals originating from a plurality of computational devices 104 on the combined signal 112. In such instances, the video appliance 116 could selectively display a selected one of the plurality of converted signals by tuning to the channel corresponding to the selected converted signal.

A number of applications may be realized by such an arrangement. Some examples of such applications are presented herein to illustrate the versatility of the arrangement, but further applications will be evident to those of skill in the art. For example, in an embodiment where the video appliance 116 is configured only to display a single channel tuned from an input having a plurality of channels, it may be used selectively to tune to any of the television video signals originating from the external source or to tune to the converted computer video signal. A television without PIP capability is an example of such a video appliance. Thus, with such a configuration, an individual watching a television program on the video appliance 116 could periodically change the channel, such as during a commercial break, to view content originating from one of the computational devices 104. Where the data appliance 100 is configured to provide converted signals from a plurality of computational devices 104 on the combined signal 112, the individual might, for example, tune to channel 68 to view the content from the first computational device 104-1 and tune to channel 69 to view the content from the second computational device 104-2.

In an embodiment where the video appliance 116 is configured to display multiple channels simultaneously, such as by using the PIP function shown schematically in FIG. 1, the display may include any of the channels selected from the combined signal 112. For example, the main display on the video appliance 116 could be tuned to one of the television video signals originating from an external source while the embedded picture 120 is used to display one of the converted signals, in the illustrated case from computational device 104-2. In instances where a plurality of converted signals are comprised by the combined signal 112, the viewer of the video appliance 116 has the additional flexibility to change the content of the embedded picture 120 by retuning. Moreover, the flexibility of the arrangement additionally permits the viewer to tune the main picture of the video appliance 116 to one of the converted signals from the computational devices 104 as desired. Also, since either the main picture or the embedded picture may be tuned to any of the channels on the combined signal 112, a viewer may arrange to have two converted signals from different computational devices 104 displayed at the same time. In still other embodiments where the video appliance 116 is provided with the capacity to display more than two images simultaneously, any combination of signals chosen by the viewer may be displayed, including zero or more externally originating signals and zero or more signals originating from the computational devices 104.

Irrespective of the specific capabilities of the video appliance 116, the flexibility of the viewer to select any desired combination of signals according to the number of possible simultaneous displays permits a variety of applications. For example, one of the converted signals may comprise any information available from the Internet as accessed by one of the computational devices 104. Such information could include, for example, sporting events, movies, music videos, and/or any other digital media. The ability to access such information directly from the Internet in this fashion avoids restrictions placed on the external television-signal content by an external service provider according to timetable, geographic, or other restrictions. In another embodiment, stock-market monitoring may be accessible for display by the video appliance 116 by one of the computational devices 104 connecting to a stock-market web site over the Internet. In a further embodiment, TV guide information may be accessible by one of the computational devices 104 connecting to a TV guide web site; when the video appliance 116 includes PIP or other multidisplay capability, it is thus possible for a viewer to change the channel of a program while maintaining a view of the TV guide information. The scope of content that may be displayed on the video appliance 116 in accordance with embodiments of the invention is as diverse as the scope of information accessible by one of the computational devices.

For example, in other embodiments, the system may serve as an electronic-mail monitoring system. By having one of the computational devices 104 connected to an electronic-mail site, a change in the display corresponding to the signal from that computational device 104 indicating the arrival of new messages may conveniently be viewed on the video appliance 116.

In one embodiment, display of a converted signal originating at one or more of the computational devices 104 may be used to monitor activity on the computational device 104, which may be located elsewhere within a home. This may advantageously be used as part of a parental monitoring function, such as when a parent watching programming on the video appliance 116 may simultaneously see what activity is taking place on a computational device 104 being used by a child. In embodiments where multiple children have access to different computational devices 104, the ability of the data appliance 100 to provide separate channels for converted signals from each of the computational devices 104 permits a parent to switch conveniently back and forth among displays from the different computational devices 104 by tuning the video appliance 116.

It is noted that the arrangement shown in FIG. 1 also permits use of each of the computational devices 104 and of the video appliance 116 without display of converted signals in instances where that is desired. For example, if one parent in a home wishes to watch television programming and the other separately wishes to view material over the Internet, each may perform those activities unimpeded by the activities of the other. The functionality of the computational devices 104 is unaffected by use of the data appliance 100, and the video appliance 116 may still be tuned to the desired programming.

FIG. 2 provides a schematic illustration of a structure for the data appliance 100 that may be used in an embodiment. The illustration is provided for conversion of VGA signals 212 from the computational devices 104 into NTSC signals, but it will be appreciated by those of skill in the art that equivalent techniques may be used for conversion of any type of computer video signals into any type of television video signals. Each of the VGA signals 212 from the computational devices 104 is received by a VGA-to-NTSC converter 200, specific exemplary structures of which are described further below. Operation of the VGA-to-NTSC converter 200 is controlled by a processor 220 to select one of the received VGA signals 212 and to convert it to an NTSC signal. The resulting NTSC signal is provided to an rf modulator 204, which acts in accordance with control by the processor 220 to modulate the NTSC signal onto a particular channel. The modulated signal is then combined with the external television video signals 108 with a combiner 208 to produce the combined signal 112. Coordinated control of each of the VGA-to-NTSC converter 200, rf modulator 204, and combiner 208 permits the selected one of the received VGA signals 212 to be provided on the combined signal 112 with the desired channel.

In some embodiments, the data appliance 100 additionally includes a storage device 224 in communication with the processor 220 for receiving a copy of modulated signals from the rf modulator 204. This permits retrieval of the stored signals from the storage device 224 as may be desired for replay. Thus, merely by way of example, the storage capacity of the data appliance 100 may be used in an embodiment where a parent wishes to monitor use of a computational device 104 by a child, in particular to review which Internet web sites may have been accessed by the child. If the child uses the computational device 104 when the parent is absent, the child's activity may be recorded on the storage device 224 and may later be replayed over the video appliance 116 for review by the parent. More generally, the storage capacity of the data appliance 100 may be used to review any signals that are received from the computational device 104 and provided at a later time to the video appliance 116.

While the storage device 224 is shown internal to the data appliance 100, in other embodiments an external data store 228 may be used alternatively or in addition. The external data store 228 could use a moveable storage medium, such as in an embodiment where a video-cassette recorder (“VCR”) is used for storage. Such embodiments thus provide an alternative mechanism for using the monitoring capabilities of the data appliance. For example, where a parent wishes to monitor use of a computational device 104 by a child, the child's activity could be recorded on a video cassette for later review by the parent.

The processor 220 may also be equipped with an interface 216 that permits the processor to be programmed. In one embodiment, the programming may be provided over the interface 216 with one of the computational devices 104, although the interface may be used with any suitable programming device known to those of skill in the art. Such programming may be used to define the operation of the data appliance 100, including defining such parameters as which data streams from the computational devices 104 are to be mapped onto which channels of the combined signal 112. In addition, the programming capability may be used to define parameters under which signals should be recorded on the storage device 224, such as by specifying the time or other conditions to perform such recording. The interface capability with the processor 220 may also be used to request replay of stored signals when desired.

While FIG. 2 shows the VGA-to-NTSC converter 200 configured to select one of a plurality of VGA signals 212 for conversion and transmission to an rf modulator 204, in alternative embodiments a plurality of rf modulators 204 may be provided. In such instances, the VGA-to-NTSC converter 200 may be configured to transmit each of a plurality of VGA signals to respective ones of the plurality of rf modulators 204 after conversion to an NTSC signal. Each of the rf modulators 204 may then modulate the signals differently so that when they are combined with the external television video signals 108 by the combiner 208, they become accessible on different channels by the video appliance 116. This provides the access to data streams from multiple computational devices 104 to enable such embodiments described above.

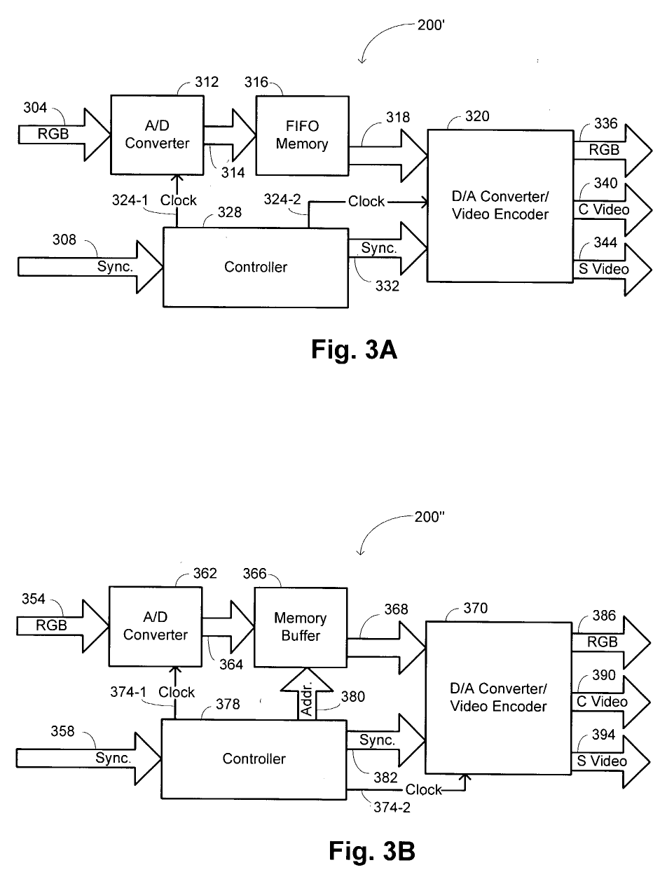

The functionality of the VGA-to-NTSC converter 200 to convert received computer video signals into television video signals may be realized in a variety of different ways. Some such mechanisms are described in connection with FIGS. 3A and 3B, although other mechanisms will also be known to those of skill in the art. A first example of a VGA-to-NTSC converter in a specific embodiment is shown in FIG. 3A and denoted 200′. As indicated, the incoming VGA signal 212 is initially separated into a standard red-green-blue (“RGB”) signal 304 and a sync signal 308. The sync signal 308 itself may comprise vertical and horizontal sync signals or may comprise a composite sync signal. The RGB signal 354 includes information defining pixel color information and the sync signal 308 includes information defining how to synchronize the information to produce color images for display.

The RGB signal 304 is provided to an analog-to-digital converter 312 for conversion to a digital signal that is provided to a first-in-first-out (“FIFO”) memory 316. The sync signal 308 is provided to a controller 328. A combination digital-to-analog converter and video encoder receives signals 318 and 332 respectively from the FIFO memory 316 and controller 328 to produce output RGB signals 336, C video signals 340, and S video signals 344 that define the resultant NTSC signal. Operation of the device is coordinated with clock signals 324-1 and 324-2 from the controller to the analog-to-digital converter 312 and digital-to-analog converter/video encoder 320 respectively.

The operation of the controller 328 to effect the conversion may be illustrated with specific examples of typical video characteristics, with other examples being evident to those of skill in the art after reading this description. For example, in one embodiment, the VGA signals 212 define a non-interlaced picture having a 60-Hz refresh rate and a horizontal scan frequency that is twice the NTSC horizontal scan frequency. In such an instance, the controller 328 is configured so that the first odd-number scanline shown in the VGA image is stored in the FIFO memory 316. The stored scanline is then sent out at half speed and encoded to an NTSC video signal. Subsequently, the next odd scanline is stored in the FIFO memory 316. The even-numbered scanlines are subsequently handled in the same fashion, resulting in an interlaced NTSC signal at a 60-Hz refresh rate. The operation may be complicated when the refresh rate of the VGA signals 212 differs from the desired refresh rate of the output television video signals, such as when VGA signals 212 are to be converted to PAL signals. In such instances, an additional driver may be provided to set all VGA modes to the 50-Hz rate used by PAL signals, with the horizontal scan rate for PAL output still being made by halving the VGA horizontal scan rate.

In instances where the VGA refresh rate is substantially the same as the refresh rate of the television video signals to be output, a similar conversion technique may be used even where the horizontal sync rate of the VGA signals is not exactly twice the horizontal sync rate of the television video signals. In such instances, the controller 328 may be provided with information regarding the ratio of sync rates, thereby defining how many VGA scanlines correspond to a single television scanline. The translation is done as before, but with the conversion being performed on the basis of the ratio of sync rates rather than for every second scanline. There is no a priori requirement with such a technique that the ratio of sync rates be an integer.

Another structure for the VGA-to-NTSC converter is shown in FIG. 3B and designated 200″. As for the embodiment shown in FIG. 3A, the incoming VGA signal 212 is initially separated into a standard RGB signal 354 and a sync signal 358, which may comprise vertical and horizontal sync signals or may comprise a composite sync signal. The RGB signal 354 is provided to an analog-to-digital converter 362 for conversion to a digital signals that is provided to a memory buffer 366, and the sync signal 358 is provided to a controller 378. A combination digital-to-analog converter and video encoder 370 receives signals 368 and 382 respectively from the memory buffer 366 and the controller 378 to produce output RGB signals 386, C video signals 390, and S video signals 394 that define the resultant NTSC signal. In addition to operation of the device being coordinated with clock signals 374-1 and 374-2 from the controller to the analog-to-digital converter 362 and the digital-to-analog converter/video encoder 370 respectively, addressability 380 is provided from the controller 378 to the memory buffer 366. Thus, one part of the device 200″ digitizes the incoming VGA signals 212 at the rate sent from the computational device 104 and stores the digitized signals in the memory buffer 366. Another part of the device 200″ reads the digitized signals from the memory buffer 366 at the rate appropriate for the output television video signals.

In some instances, additional capability may be provided to the VGA-to-NTSC converter 200, such as with devices that reduce flicker, provide zooming capability, and change resolution characteristics.

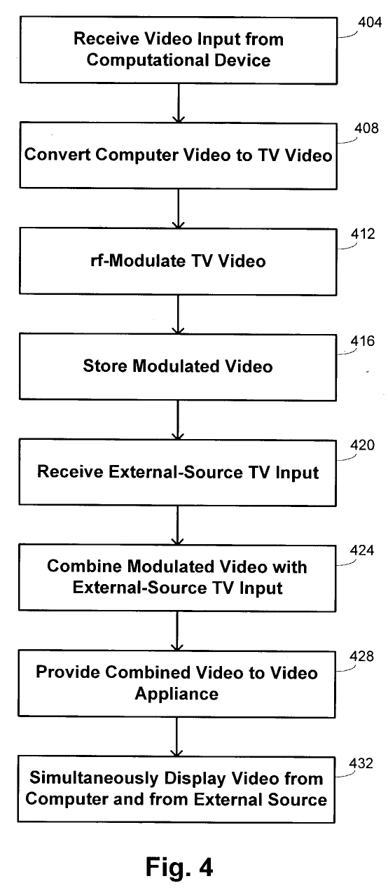

The operation of the systems described in connection with FIGS. 1-3B are conveniently summarized with the flow diagram shown in FIG. 4. In this diagram, a series of blocks are provided that illustrate functions that may be performed as part of delivering a data stream to a video appliance in accordance with embodiments of the invention. Neither the order nor the number of functions indicated is required, and some embodiments of the invention include the performance of fewer or more of the indicated functions and/or include the performance of some of the indicated functions in a different order. Furthermore, while some of the functions may be performed using the apparatus discussed above, they may also be performed with alternative and/or equivalent apparatus, as will be known to those of skill in the art after reading this disclosure.

A method for delivering a data stream to a video appliance may begin at block 404 by receiving video input from a computational device in the form of one or more computer video signals. At block 408, the computer video signals are converted to television video signals. At block 412, the converted video signals are rf-modulated to permit their identification according to a tunable channel. At block 416, the modulated signals may be stored to permit their later recovery for display of video that they define. At block 420, television video signals may also be received from an external source, such as from a cable-service or satellite-service provider. The received external-source television video signal are combined with the modulated signals at block 424. The combined signal is provided to a video appliance at block 428. By selecting specific channels from the combined signal, the desired video signals, either originating from the external source or from the computational device, may be viewed. In some instances, they may be viewed simultaneously on the video appliance as indicated at block 432.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for delivering a data stream having a computer video signal from a computational device to a video appliance, the method comprising:
receiving the data stream from the computational device;
converting the computer video signal to a converted television video signal;
combining the converted television video signal with a plurality of television video signals received from an external source; and
transmitting the combined television video signals to the video appliance.

2. The method recited in claim 1 further comprising rf modulating the converted television video signal, whereby the converted television video signal may be selected for display on the video appliance by tuning the video appliance.

3. The method recited in claim 1 further comprising tuning to an rf modulation of the converted television video signal.

4. The method recited in claim 1 further comprising displaying the converted television video signal on the video appliance.

5. The method recited in claim 4 further comprising displaying one of the plurality of television video signals received from the external source on the video appliance simultaneously with the converted television video signal.

6. The method recited in claim 5 wherein the converted television video signal is displayed with a picture-in-picture capability of the video appliance.

7. The method recited in claim 1 wherein the data stream is extracted from an Internet site.

8. The method recited in claim 1 further comprising storing the converted television video signal.

9. The method recited in claim 8 further comprising retrieving the stored converted television video signal prior to combining the converted television video signal with the plurality of television video signals.

10. The method recited in claim 1 wherein converting the computer video signal to the converted television video signal comprises changing a refresh rate of the computer video signal.

11. The method recited in claim 1 wherein the data stream is one of a plurality of data streams provided by a plurality of computational devices, the method further comprising selecting the data stream from the plurality of data streams.

12. The method recited in claim 1 further comprising:
receiving a second data stream having a second computer video signal from a second computational device;
converting the second computer video signal to a second converted television video signal; and
combining the second converted television video signal with the converted television video signal and plurality of television video signals received from the external source.

13. The method recited in claim 12 further comprising:
rf modulating the converted television video signal with a first modulation; and
rf modulating the second converted television video signal with a second modulation,
whereby either of the converted television video signals may be selected for display on the video appliance by tuning the video appliance.

14. The method recited in claim 13 further comprising displaying the converted television video signal and the second converted television video signal simultaneously on the video appliance.

15. A data appliance comprising:
a conversion element adapted to convert a received computer video signal to a converted television video signal;
a combiner adapted to combine the converted television video signal with a plurality of television video signals received from an external source; and
a processor in communication with and adapted to coordinate operation of the conversion element and the combiner.

16. The data appliance recited in claim 15 further comprising an rf modulator adapted to modulate the converted television video signal, wherein the processor is further in communication with and adapted to coordinate operation of the rf modulator.

17. The data appliance recited in claim 15 further comprising a storage device adapted to store the converted television video signal.

18. The data appliance recited in claim 17 wherein the storage device is disposed within internal to the data appliance.

19. The data appliance recited in claim 15 wherein the processor is configured for communication with a storage device disposed external to the data appliance.

20. The data appliance recited in claim 15 wherein:
the conversion element is further adapted to convert a second received computer video signal to a second converted television video signal; and
the combiner is further adapted to combine the second converted television video signal with the converted television video signal and the plurality of television video signals received from the external source.

21. The data appliance recited in claim 20 further comprising:
a first rf modulator adapted to modulate the converted television video signal with a first modulation; and
a second rf modulator adapted to modulate the second converted television video signal with a second modulation.

22. The data appliance recited in claim 15 wherein the processor includes an interface for accepting programming information.

23. A system comprising:
a video appliance;
a computational device; and
a data appliance adapted to receive a data stream having a computer video signal from the computational device and to transmit a conversion of the computer video signal to a converted television video signal to the video appliance as part of a plurality of television video signals.

24. The system recited in claim 23 wherein the data appliance is further adapted to combine the converted television video signal with a plurality of television video signals received from an external source.

25. The system recited in claim 23 wherein the data appliance is further adapted to rf modulate the converted television video signal.

26. The system recited in claim 25 wherein the video appliance is adapted to accept tuning information to select the converted television video signal from the plurality of television video signals according to a modulation provided by the data appliance.

27. The system recited in claim 23 wherein the video appliance is adapted to display multiple of the plurality of television video signals simultaneously.

28. The system recited in claim 23 wherein the computational device includes a connection to an Internet site and the data stream is extracted from the Internet site.

29. A data appliance comprising:
means for converting a received computer video signal to a converted television video signal;
means for combining the converted television video signal with a plurality of television video signals received from an external source; and
means for transmitting the combined television video signals to a video appliance.

30. The data appliance recited in claim 29 further comprising means for rf modulating the converted television video.

31. The data appliance recited in claim 29 further comprising means for storing the converted television video signal.

32. The data appliance recited in claim 29 further comprising means controlling the means for converting, the means for combining, and the means for transmitting.

33. The data appliance recited in claim 32 further comprising means for interfacing with the means for controlling.
